(19) United States
(12) Patent Application Publication
(10) Pub. No.: US 2009/0133067 A1
(43) Pub. Date: May 21, 2009

(54) Multi-media enhancement channel

(76) Inventors: Itay Sherman, Hod Hasharon (IL); Eyal Bychkov, Hod Hasharon (IL)

Correspondence Address: Soquel Group, LLC, P.O. Box 691, Soquel, CA, 95073, US

(21) Appl. No.: 11/986,242

(22) Filed: Nov. 19, 2007

(51) Int. Cl. G06F 3/00

(52) U.S. Cl. 725/43

(57) ABSTRACT

A media ticker system for overlaying side channel information on a video display, including a portable media player for presenting a content media file on a video display, and for overlaying ticker display data on the video display with the content media file being presented, a ticker manager connected to the media player for receiving as input at least one attribute of the content media file being presented by the media player, and for producing as output informative data relevant to the content media file, and a ticker generator communicatively coupled with the ticker manager and with the media player, for receiving as input the informative data relevant to the content media file produced by the ticker manager, and for producing as output the ticker display data for overlay on the video display with the content media file being played. A method is also described and claimed.

### FIELD OF THE INVENTION

The field of the present invention is digital media presentation.

### BACKGROUND OF THE INVENTION

Many common consumer electronic devices, including inter alia computers, cell phones, portable media players, game stations, digital cameras and camcorders, present multi-media content to users on video displays. Content presented on video displays may be stored locally on the player as content media files, or streamed on-line over a broadcast channel or as a point-to-point Internet connection.

Some multi-media content providers bundle their media content together with side channel information that is presented in the form of a rolling ticker. Such side channel information may be a channel enhancement that enhances the multi-media viewing experience, and may provide directed advertising to the viewer. For example rolling ticker information is often used to display stock price and index information during financial news broadcasts, and to display artist information during broadcast of an artist's video clip.

Side channel information may be packaged directly with the broadcast video, as is done with analog TV broadcast, or may be integrated as a separate digital stream bundled together with the digital video and audio streams, as is done with digital TV broadcast. Side channel information may be presented as-is, or may include references to URL connections that are accessed over separate communication channels.

Generally, bundling of media content with side channel information is prescribed by a content provider, and the overlay of the side channel information with the video content may be performed by the player.

It would thus be useful to provide a flexible architecture for generating, managing and displaying side channel ticker display data, that allows for a diversity of source and merge points.

### SUMMARY OF THE DESCRIPTION

The present invention provides an architecture for on-the-fly generation, management and overlay of side channel ticker data. As a user interactively selects media for video presentation on a media player, informative data relevant to the media being played is searched, collected, filtered and transformed into a rolling ticker display that is overlaid on the video presentation. For example, when a user plays a music video, a rolling ticker overlaid on the music video may display artist information and other music videos by the same artist; and when a user plays a movie, a rolling ticker overlaid on the movie may display lead actor information and other movies that have the same lead actors. Additionally, the rolling ticker may include selection points, which may be activated by the user to enable transactions such as purchasing media and purchasing tickets to a performance.

The present invention provides a ticker manager that generates and transmits ticker information to the media player. The ticker manager architecture is flexible, and encompasses many different networked embodiments.

The media file being played may reside locally in the player's memory, or in another device's memory, or may be arriving via streaming from an Internet content server. Search and collection of informative data from content being played by the player may be performed by the ticker manager, or by a dedicated ticker server that identifies content based on attributes thereof. Ticker information is formatted according to display characteristics of the player's video display.

In a more general embodiment of the present invention, the nature of the ticker information may be user driven. I.e., instead of providing information related to the content being player by the player, the ticker information may instead be related to a different topic. E.g., a user may wish to have sports information or financial information delivered as ticker data, while he is watching an action movie.

It will thus be appreciated by those skilled in the art that the present invention provides an end-to-end system for dynamically authoring, publishing, generating and overlaying ticker display information with content being presented on a video display.

Although ticker displays themselves are not new, the present invention, in distinction to the prior art, uses a ticker manager that collects relevant information, organizes the information based on the available screen, and displays the information.

There is thus provided in accordance with an embodiment of the present invention a media ticker system for overlaying side channel information on a video display, including a portable media player for presenting a content media file on a video display, and for overlaying ticker display data on the video display with the content media file being presented, a ticker manager connected to the media player for receiving as input at least one attribute of the content media file being presented by the media player, and for producing as output informative data relevant to the content media file, and a ticker generator communicatively coupled with the ticker manager and with the media player, for receiving as input the informative data relevant to the content media file produced by the ticker manager, and for producing as output the ticker display data for overlay on the video display with the content media file being played.

There is moreover provided in accordance with an embodiment of the present invention a media ticker system for overlaying side channel information on a video display, including a portable media player for presenting a movie on a video display, a ticker manager connected to the media player for receiving as input at least one attribute of the movie being presented by the media player, and for producing as output informative data relevant to the movie, and a ticker generator communicatively coupled with the ticker manager and with the media player, for receiving as input from the media player a frame of the movie, and for receiving as input from the ticker manager the informative data relevant to the movie, and for producing as output for the media player a composite frame with ticker display data overlaying the frame of the movie, wherein the ticker display data includes the informative data relevant to the content media file.

There is additionally provided in accordance with an embodiment of the present invention a method for overlaying side channel information on a video display in the form of a ticker display, including presenting a content media file on a video display, receiving at least one attribute of the content media file being presented, determining informative data relevant to the content media file, based on the at least one attribute of the content media file, transforming the informative data relevant to the content media file to ticker display data, and overlaying the ticker display data on the video display.

There is further provided in accordance with an embodiment of the present invention a method for overlaying data on a video display in the form of a ticker display, including providing a content media file, receiving a selection of a topic from a user, determining informative data relevant to the selected topic, transforming the informative data relevant to the selected topic to ticker display data, and overlaying the ticker display data on a video display.

There is yet further provided in accordance with an embodiment of the present invention a method for overlaying data on a video display in the form of a ticker display, including providing a movie, receiving a selection of a topic from a user, determining informative data relevant to the selected topic, transforming the informative data relevant to the selected topic to ticker display data, and compositing the ticker display data with at least one frame of the movie, for rendering on a video display.

### BRIEF DESCRIPTION OF THE DRAWINGS

The present invention will be more fully understood and appreciated from the following detailed description, taken in conjunction with the drawings in which:

FIG. 1 is an illustration of ticker data overlaid on a movie frame, in accordance with an embodiment of the present invention;

FIG. 2 is a simplified block diagram of a system for generating ticker display overlays, in accordance with an embodiment of the present invention;

FIG. 3 is a simplified flowchart of a method for generating ticker display overlays using a ticker manager, in accordance with an embodiment of the present invention;

FIG. 4 is a simplified flowchart of a method for generating ticker display overlays using a server computer, in accordance with an embodiment of the present invention;

FIG. 5 is a simplified block diagram of an alternative system for generating ticker display overlays using a ticker manager, in accordance with an embodiment of the present invention; and

FIG. 6 is a simplified flow chart of method for generating ticker display overlays with ticker data for a user-selected topic, using a ticker manager, in accordance with an embodiment of the present invention.

### DETAILED DESCRIPTION

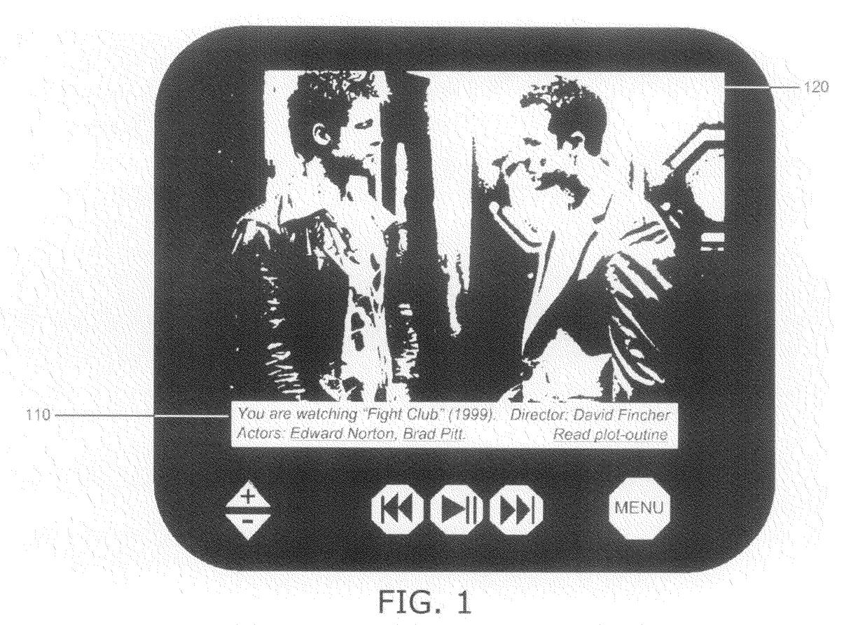

Aspects of the present invention relate to methods and systems for generating side channel rolling ticker display information for media content, and for overlaying the ticker display information on the media content while the content is being presented on a video display. In this regard, reference is now made to FIG. 1, which is an illustration of ticker data 110 overlaid on a movie frame 120, in accordance with an embodiment of the present invention. Ticker data 110 includes the title, director and actors of the movie, with links to information about the director, about the actors, and about the movie's plot.

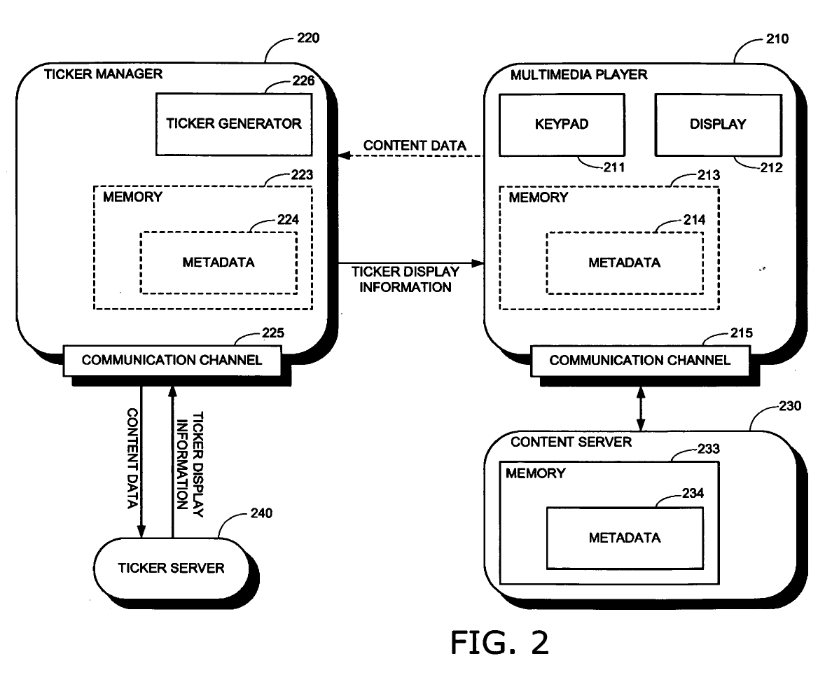

Reference is now made to FIG. 2, which is a simplified block diagram of a system for generating ticker display overlays, in accordance with an embodiment of the present invention. Shown in FIG. 2 is a multi-media player 210, which captures and presents multi-media content, such as movie 120. Multi-media player 210 is connected to a ticker manager 220 that generates side channel information for overlay on the multi-media content presented by player 210. The side channel information is overlaid in the form of a running ticker, such as ticker data 110.

The connection between multi-media player 210 and ticker manager 220 is generally a physical communication connection.

Multi-media player 210 includes a keypad 211, a video display 212 and a memory 213. Multi-media player 210 also includes a communication channel 215 that connects player 210 to a content server 230.

Ticker manager 220 includes a memory 223. In accordance with an embodiment of the present invention, memory 223 is exposed to media-player 210 as a mass storage device, via a USB interface, or an SD interface, or such other interface that enables media-player 210 to access ticker manager memory 223.

Ticker manager 220 includes a communication channel 225 that connects ticker manager 220 to a ticker server computer 240. Ticker manager 220 also includes a ticker generator 226, which generates ticker display information for overlap on content presented on display 212. Ticker display information may be formatted as simple bitmap data that is overlaid on display 212, or as higher level description data such as XML or HTTP data, which is processed by player 210 prior to being overlaid on display 212.

Content server 230 stores content files in a memory 233, and transmits content files to media player 210 for storage in memory 213. Content 230 also streams content files to player 210 for direct presentation on display 212, without saving the content as a file.

Server computer 240 may be an Internet server, or a dedicated ticker server.

Multi-media content presented by multi-media player 210 may reside locally in memory 213, or remotely in memory 223. I.e., memory 223 may serve as a storage device for multi-media player 210, as described hereinabove. In the former case, where content resides locally on player 210, memory 223 is optional. Conversely, in the latter case, where memory 223 serves as a storage device for player 210, memory 213 is optional.

In accordance with an embodiment of the present invention, ticker manager 220 is aware of the specific multi-media content being captured or played on player 210. Specifically, for multi-media content that is stored locally on memory 213, player 210 sends a notification to ticker manager 220 when a user chooses to play a specific media file on player 210. Such notification includes meta-data for the specific content. For multi-media content that is stored remotely on memory 223, ticker manager 220 is aware that a specific media file in memory 223 is being accessed by player 210.

Meta-data for multi-media content is used to identify the content and its source. Meta-data for music content, for example, generally includes an artist name, a track title, an album title, a genre, a release year and a track number. Meta-data 214 may be stored locally on player 210 in memory 213. Meta-data 224 may also or alternatively be stored remotely on ticker manager 220 in memory 223. Meta-data 234 for downloaded content files and for media that is streamed from content server 230 is stored in memory 233.

If meta-data is not available for specific multi-media content, then services are available for determining meta-data from attributes of the content, such as a file name and a file length. Alternatively, the content may be played to a dedicated content identification server, and the server identifies the content and provides its meta-data. Content identification servers are well-known. The Tunatic™ software available at http://www.wildbits.com/tunatic/ is able to analyze a song being played on a computer, via a microphone or via a desktop, and provides artist name and track title. MusicBrainz™ provides a music metadata database at http://musicbrainz.org. 411Song™ is a “name that tune” service provided by NMK, Inc. of New York, N.Y., available at http://www.411song.com/, which listens to a song for approximately 15 seconds and derives the artist name.

In accordance with an embodiment of the present invention, ticker manager 220 performs content identification, or alternatively ticker server 240 provides such a content identification service, or both. Ticker manager 220 performs a web search for content informative data and retrieves the data, and ticker generator 226 filters the data and re-formats the data for overlay on content presented on display 212. Alternatively, ticker manager 220 passes information about the content being presented on player 210, along with display characteristic information for display 212, to ticker server 240. In such case, ticker server 240 retrieves the content informative data, and returns to ticker manager 220 ticker-ready data for overlay on content presented on display 212.

For example, a user selects a specific movie to play on a portable movie player 210. The movie is stored locally as a file in memory 213. Player 210 accesses the movie file, and begins playing the movie. Player 210 also sends a notification to ticker manager 220, including the movie title and other meta-data from the movie file header. In turn, ticker manager 220 performs a web search for the movie title and retrieves information about lead actors. Ticker manager 220 then searches for other movies that the lead actors starred in. Ticker generator 226 processes the information and formats the information into a rolling ticker with actors' names and movie information, such as ticker data 110.

Ticker generator 226 formats ticker display information as bitmap image data that overlay parts of display screen 212. Alternatively, ticker generator 226 formats ticker display information in a higher level description format, such as XML or HTTP, which is processed by player 210 prior to being overlaid on display screen 212.

In accordance with an embodiment of the present invention, ticker display information includes selection points, in the form of hyper-links and controls, for player 210 to present to a viewer. For example, a selection point may enable a purchase, with text such as “Press the blue button for purchasing tickets.” Selection point text may be transferred as part of the image. Key presses by keypad 211 on display 212 are transmitted to ticker manager 220. In response, ticker generator 226 generates updated display information for player 210, or alternatively ticker manager 220 triggers an exchange over communication channel 225, such as purchase of a ticker over the Internet.

In an alternative embodiment of the present invention, selection point data may be transferred using an XML schema, or HTTP, with specified user interaction elements.

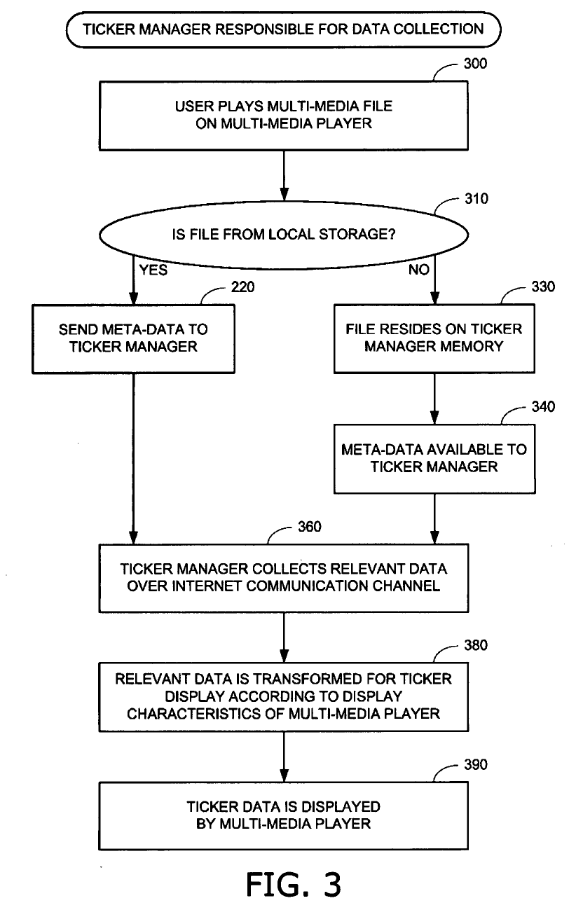

Reference is now made to FIG. 3, which is a simplified flowchart of a method for generating ticker display overlays using a ticker manager, in accordance with an embodiment of the present invention. At step 300 a user plays a media file on a multi-media player, such as player 210 of FIG. 2. At step 310 a determination is made whether the media file being played is stored locally on player 210, or stored on ticker manager 220. If the file is stored locally on player 210, then at step 320 player 210 sends meta-data for the file to the ticker manager. The method then advances to step 350. Referring back to step 310, if the media file being played is not stored locally on player 210, then the file resides on the ticker manager, and meta-data for the file is available to the ticker manager, as indicated at steps 330 and 340.

At step 360 the ticker manager collects relevant informative data for the media file over an Internet communication channel. At step 380 the ticker manager organizes the relevant informative data for overlay on the media presented by the player, according to the player's display characteristics. Finally, at step 390 the ticker data is overlaid on the media presented by the player.

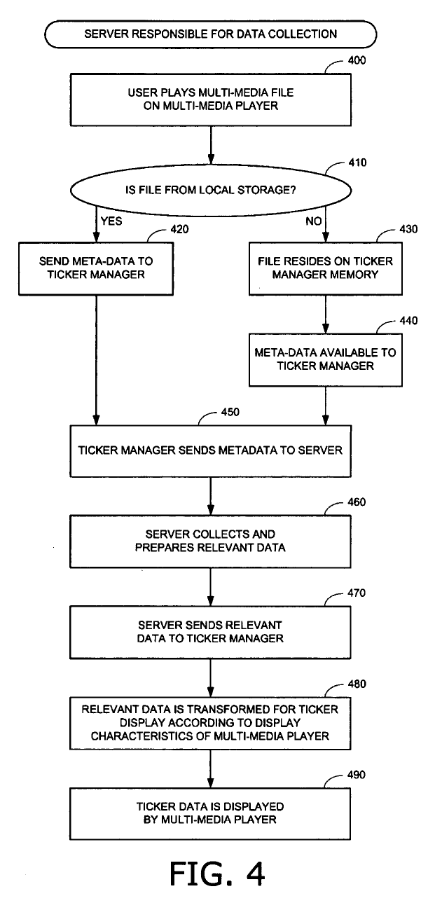

Reference is now made to FIG. 4, which is a simplified flowchart of a method for generating ticker display overlays using a server computer, in accordance with an embodiment of the present invention. The steps shown in FIG. 4 are analogous to their respective counterpart steps in FIG. 3. However, at step 450 the ticker manager sends meta-data for the media file to an Internet server, such as server 240 of FIG. 2. At step 460 the Internet server collects and prepares the relevant informative data for the media file. At step 470 the Internet server sends the relevant informative data to the ticker manager.

At steps 380 and 390 of FIG. 3, and at steps 480 and 490 of FIG. 4, it was assumed that multi-media player 210 receives ticker display data 110 from ticker manager 220, and composites movie frame 120 and overlaid ticker data 110. In an alternative embodiment of the present invention, ticker manager 220 composites movie frame 120 and overlaid ticker data 110; i.e., ticker manager 220 prepares the full display image for multi-media player 210, including both the movie frame and the overlaid ticker data, and multi-media player 210 simply displays the composited movie frame.

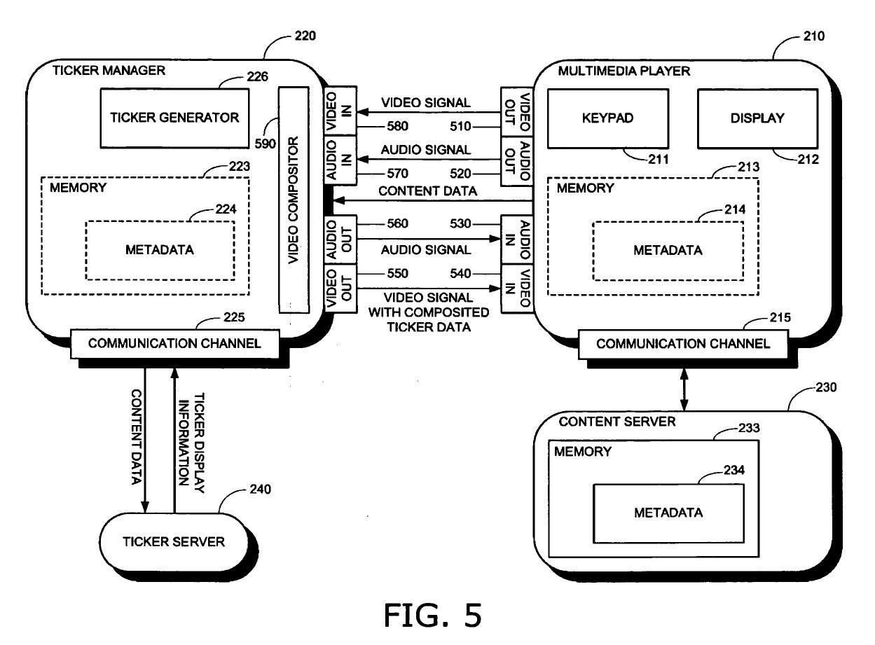

In the regard, reference is now made to FIG. 5, which is a simplified block diagram of an alternative system for generating ticker display overlays using a ticker manager, in accordance with an embodiment of the present invention.

In this alternate embodiment, multi-media player 210 includes video-out, audio-out, audio-in and video-in jacks 510, 520, 530 and 540, respectively. Ticker manager 220 includes video-out, audio-out, audio-in and video-in jacks 550, 560, 570 and 580, respectively. Multi-media player 210 sends original video and audio signals to ticker manager 220 via the multi-media player's video-out and audio-out jacks, respectively. The original video signal includes uncomposited movie frames. Ticker manager 220 includes a video compositor 590, which processes the original video signal by compositing the ticker display data therewith. Ticker manager 220 sends the composited video signal and the original audio signal back to player 210. In turn, player 210 plays the original audio and composited video signals to the user.

Sending the original audio signal back and forth between player 210 and ticker manager 220 is performed in order that the audio be in sync with the video. The original audio signal is unchanged. It is synchronized and sent back to player 210 after a small time delay; namely, the time for video compositor 590 to process the video signal.

In a more general embodiment, the present invention may be used to provide ticker data for a user-specified topic, instead of ticker data related to content being displayed by player 210. E.g., a user may desire to have a sports ticker or a financial ticker data displayed on player 210, while he is watching an unrelated action movie.

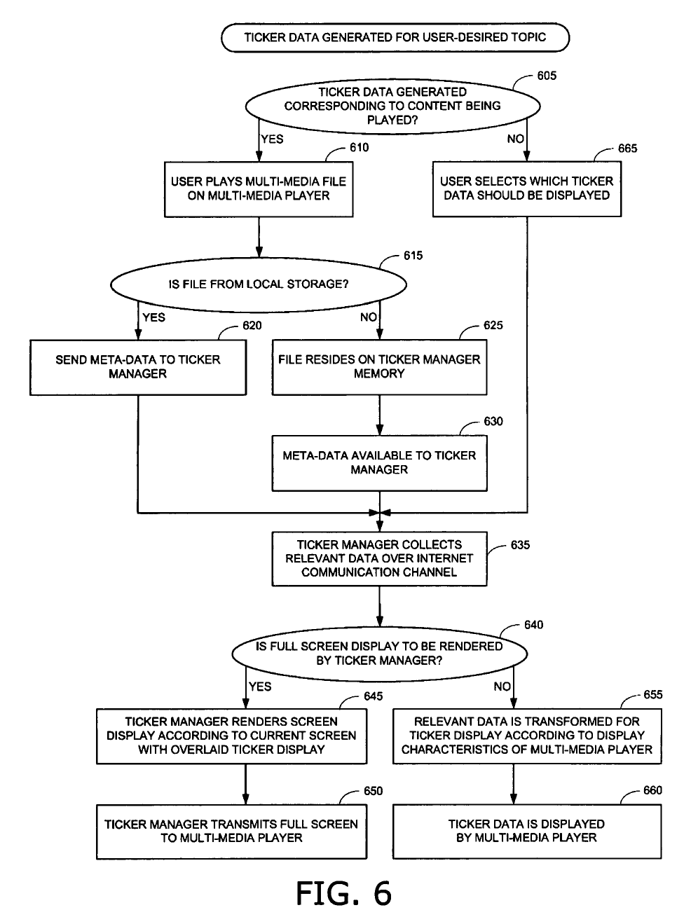

In this regard, reference is now made to FIG. 6, which is a simplified flow chart of method for generating ticker display overlays with ticker data for a user-selected topic, using a ticker manager, in accordance with an embodiment of the present invention. At step 605 a determination is made whether ticker data is to be generated corresponding to the content being played on a multi-media player, or is instead to be generated based on a user selected topic.

If the ticker data is to correspond to the content being played, then at step 610 a user plays a multi-media file on the multi-media player. At step 615 a determination is made whether or not the media file is being played from the player's local storage.

If so, then at step 620 the player sends meta-data for the media file to the ticker manager. At step 635 the ticker manager collects appropriate ticker data over an Internet communication channel. At step 640 a determination is made whether the ticker manager is responsible for rendering a full screen display for the player, or only responsible for generating the ticker display itself.

If the ticker manager is responsible for the full screen display, then at step 645 the ticker manager renders a full screen that includes both the screen for the content being player on the player and the overlaid ticker display. The ticker manager then transmits the full screen generated at step 645 to the player for display, and at step 650 the multi-media player displays the full screen received from the ticker manager.

If it is determined at step 640 that the ticker manager is only responsible for generating the ticker display itself, then at step 655 the ticker manager transforms the ticker data according to the display characteristics of the player. The ticker manager transmits the ticker display to the player, and at step 660 the multi-media player overlays the ticker display on the content being played.

If it is determined at step 615 that the media file being played by the player is not from the player's local storage, then at step 625 ticker manager concludes that the file is being played from the ticker manager's memory, and at step 630 the meta-data for the media file is available to the ticker manager. Processing then proceeds to step 635 as above.

Finally, if it is determined at step 605 that the ticker data should be generated based on a user selected topic, then at step 610 the user selects a topic for which ticker data should be displayed. Processing then proceeds to step 635 as above.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A media ticker system for overlaying side channel information on a video display, comprising:
a portable media player for presenting a content media file on a video display, and for overlaying ticker display data on the video display with the content media file being presented;
a ticker manager connected to said media player for receiving as input at least one attribute of the content media file being presented by said media player, and for producing as output informative data relevant to the content media file; and
a ticker generator communicatively coupled with said ticker manager and with said media player, for receiving as input the informative data relevant to the content media file produced by said ticker manager, and for producing as output the ticker display data for overlay on the video display with the content media file being played.

2. The media ticker system of claim 1 wherein the content media file being presented by said media player resides in a memory of said media player.

3. The media ticker system of claim 1 wherein the content media file being presented by said media player resides in a memory of said ticker manager.

4. The media ticker system of claim 1 wherein the content media file being presented by said media player is streamed to said media player over the Internet from a content server computer.

5. The media ticker system of claim 1 wherein the at least one attribute of the content media file being presented by said media player is content meta-data.

6. The media ticker system of claim 1 further comprising a ticker server computer coupled with said ticker manager for receiving as input the at least one attribute of the media file being played by said media player and for producing as output the informative data relevant to the content media file.

7. The media ticker system of claim 1 wherein the at least one attribute of the content media file being presented by said media player is a portion of the audio content of the media file.

8. The media ticker system of claim 1 wherein the at least one attribute of the content media file being presented by said media player is a portion of the video content of the media file.

9. A media ticker system for overlaying side channel information on a video display, comprising:
a portable media player for presenting a movie on a video display;
a ticker manager connected to said media player for receiving as input at least one attribute of the movie being presented by said media player, and for producing as output informative data relevant to the movie; and
a ticker generator communicatively coupled with said ticker manager and with said media player, for receiving as input from said media player an original video signal for the movie, and for receiving as input from said ticker manager the informative data relevant to the movie, and for returning as output to said media player a video signal with ticker display data overlaying the movie, wherein the ticker display data includes the informative data relevant to the content media file.

10. The media ticker system of claim 9 wherein said ticker generator also receives an original audio signal for the movie as input from said media player, and also returns the original audio signal as output to said media player, in order to synchronize the audio signal with the video signal returned to said media player.

11. The media ticker system of claim 9 wherein the movie being presented by said media player resides in a memory of said media player, and wherein said ticker manager receives the at least one attribute of the movie being presented by said media player from said media player.

12. The media ticker system of claim 9 wherein the movie being presented by said media player resides in a memory of said ticker manager, and wherein said ticker manager receives the at least one attribute of the movie being presented by said media player from the memory of said ticker manager.

13. A method for overlaying side channel information on a video display in the form of a ticker display, comprising:
presenting a content media file on a video display;
receiving at least one attribute of the content media file being presented;
determining informative data relevant to the content media file, based on the at least one attribute of the content media file;
transforming the informative data relevant to the content media file to ticker display data; and
overlaying the ticker display data on the video display.

14. The method of claim 13 wherein the content media file includes a video portion and an audio portion, wherein said overlaying the ticker display data comprises compositing the ticker display data with the video portion, and the method further comprising synchronizing the audio portion with the composited video portion.

15. The method of claim 14 wherein the at least one attribute of the content media file being presented is a segment of the audio portion of the media file.

16. The method of claim 14 wherein the at least one attribute of the content media file being presented is a segment of the video portion of the media file.

17. The method of claim 13 wherein the at least one attribute of the content media file being presented is content meta-data.

18. A method for overlaying data on a video display in the form of a ticker display, comprising:
providing a content media file;
receiving a selection of a topic from a user;
determining informative data relevant to the selected topic;
transforming the informative data relevant to the selected topic to ticker display data; and
overlaying the ticker display data on a video display.

19. The method of claim 18 wherein said determining informative data comprises collecting the informative data over the Internet.

20. A method for overlaying data on a video display in the form of a ticker display, comprising:
providing a movie;
receiving a selection of a topic from a user;
determining informative data relevant to the selected topic;
transforming the informative data relevant to the selected topic to ticker display data; and
compositing the ticker display data with at least one frame of the movie, for rendering on a video display.

21. The method of claim 20 wherein the movie includes an audio portion and a video portion, wherein said compositing comprises compositing the ticker display data with the video portion, and the method further comprising synchronizing the audio portion with the composited video portion.
